(19) United States
(12) Patent Application Publication
(10) Pub. No.: US 2022/0283304 A1
(43) Pub. Date: Sep. 8, 2022

(54) LIGHT SOURCE MODULE AND LIDAR DEVICE

(71) Applicant: Coretronic Corporation, Hsin-Chu (TW)

(72) Inventors: Yao-Shun Lin, Hsin-Chu (TW); Haw-Woei Pan, Hsin-Chu (TW); Chih-Hsien Tsai, Hsin-Chu (TW); Fu-Ming Chuang, Hsin-Chu (TW)

(73) Assignee: Coretronic Corporation, Hsin-Chu (TW)

(21) Appl. No.: 17/676,238

(22) Filed: Feb. 21, 2022

(30) Foreign Application Priority Data
Mar. 8, 2021 (CN) 202110251167.5

(51) Int. Cl. G01S 17/08; G02B 27/09; G02B 26/10; G02B 26/08; G01S 7/481

(52) U.S. Cl. CPC G01S 17/08; G02B 27/09; G02B 26/101; G02B 26/0833; G01S 7/4817; G01S 7/4815

(57) ABSTRACT

A light source module configured to provide a detection light beam and including a plurality of light-emitting elements, a light spot shaping element, and a micro-mirror element, and a lidar device having a light-emitting end and comprising the light source module are provided. The light-emitting elements are configured to provide light beams. The light spot shaping element has a plurality of light spot shaping regions configured with different deflection angles and light beam convergence capabilities corresponding to the light beams. The micro-mirror element is located on a transmission path of the light beams from the light spot shaping element. A second light beam width of each light beam corresponds to an incidence angle of each light beam incident on a reflecting surface of the micro-mirror element, such that a light spot dimension of each light beam on the reflecting surface substantially coincides with a dimension of the reflecting surface.

### CROSS-REFERENCE TO RELATED APPLICATION

This application claims the priority benefit of Chinese application no. 202110251167.5, filed on Mar. 8, 2021. The entirety of the above-mentioned patent application is hereby incorporated by reference herein and made a part of this specification.

### BACKGROUND

### Technical Field

The disclosure relates to an optical module and an optical device; particularly, the disclosure relates to a light source module and a lidar device.

### Description of Related Art

A light detection and ranging device, abbreviated as lidar device, is an optical remote sensing technique in which a distance from a target may be measured by using light. Specifically, through steering control of a detection light beam and processing of light reflected from distant objects (e.g., buildings and landscapes), the lidar device may acquire distances from and shapes of these objects, which may then serve for distance measurement, identification of the shapes of objects, and establishment of a three-dimensional geographic information model of the surroundings with high precision. In addition, the lidar device is of long measurement distance, high precision, and high identification degree, is not subject to environmental brightness, and senses information such as the shape and distance of surrounding obstacles day and night, satisfying the sensing requirements of self-driving cars for farther distance and higher accuracy.

Generally speaking, basic elements of the lidar device may include a laser light source, a light sensor, and a scanning element. For the laser light source, a semiconductor laser may be adopted, and for the light sensor, a photodiode (PD) or an avalanche photodiode (APD) may be adopted. The scanning element refers to a device that projects a light beam to different locations, and for the existing lidar scanning element, a mechanical rotating mirror, for example, may be adopted to achieve a detection mode of the surroundings in all 360-degree directions. However, a structure of the mechanical rotating mirror in the lidar may be complicated and heavy, which is one of the reasons for the high costs of product.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides a lidar device of a wide detection distance and good reliability.

Other objectives and advantages of the disclosure may be further understood from the technical features disclosed herein.

In order to achieve one, some, or all of the above objectives or other objectives, an embodiment of the disclosure proposes a light source module. The light source module includes a plurality of light-emitting elements, a light spot shaping element, and a micro-mirror element. The light-emitting elements are respectively configured to provide light beams, and each light-emitting element is arranged in parallel along a predetermined direction. The light spot shaping element has a plurality of light spot shaping regions, the light spot shaping regions are configured with different deflection angles and light beam convergence capabilities respectively corresponding to the light beams, and each light spot shaping region is located on a transmission path of each light beam. A width dimension of each light beam entering each light spot shaping region of the light spot shaping element is a first light beam width, a width dimension of each light beam leaving each light spot shaping region of the light spot shaping element is a second light beam width, and in the same light beam, the second light beam width is smaller than the first light beam width. The micro-mirror element is located on a transmission path of the light beams from the light spot shaping element. The second light beam width of each light beam corresponds to an incidence angle of each light beam incident on a reflecting surface of the micro-mirror element, such that a light spot dimension of each light beam on the reflecting surface of the micro-mirror element substantially coincides with a dimension of the reflecting surface of the micro-mirror element.

In order to achieve one, some, or all of the above objectives or other objectives, an embodiment of the disclosure proposes a lidar device. The lidar device has a light-emitting end, and includes the above light source module. The light source module is configured to provide a detection light beam.

Based on the foregoing, the embodiment of the disclosure has at least one of the following advantages or effects. In the embodiment of the disclosure, in the light source module and the lidar device, since the light-emitting elements are arranged in parallel along the predetermined direction, it facilitates control of angle tolerances of other components of the lidar device, thereby improving the accuracy of detection. In addition, in the light source module and the lidar device, by increasing the light-emitting elements in quantity, the light energy of the emitted detection light beam is also increased. Besides, in the light source module and the lidar device, each of the light spot shaping regions of the light spot shaping element is configured to deflect the light beams to different degrees, and has different light beam convergence capabilities corresponding to the light beams, and based on the different incidence angles of the light beams incident on the micro-mirror element, the light beam widths of the light beams leaving the light spot shaping regions of the light spot shaping element can be adjusted, thereby increasing the light reception efficiency. In this way, in the lidar device, the light energy of the emitted detection light beam is further increased, thereby increasing the measurement distance and improving the signal-to-noise ratio, and improving the accuracy of detection.

Other objectives, features and advantages of the present invention will be further understood from the further technological features disclosed by the embodiments of the present invention wherein there are shown and described preferred embodiments of this invention, simply by way of illustration of modes best suited to carry out the invention.

To make the aforementioned more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a light beam of a lidar device during detection according to an embodiment of the disclosure.

FIG. 2 is a schematic diagram of an internal architecture of the light source module of FIG. 1.

FIG. 3A is a top view of the light source module of FIG. 2.

FIG. 3B is a side view of the light source module of FIG. 2.

FIG. 4A to FIG. 4C are schematic diagrams of light paths of the light source module of FIG. 2 in different view angles.

FIG. 5 is a schematic diagram of another architecture of the light source module of FIG. 1.

FIG. 6 is a schematic diagram of yet another architecture of the light source module of FIG. 1.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

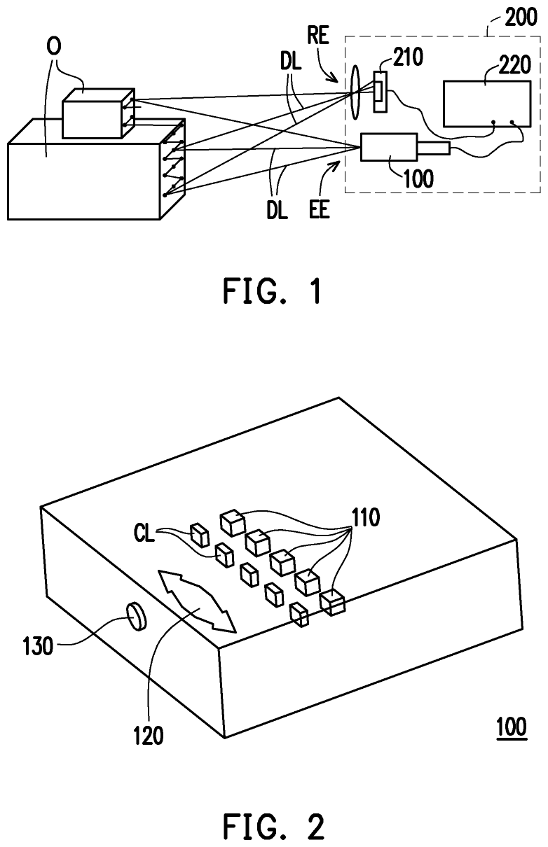

FIG. 1 is a schematic diagram of a light beam of a lidar device during detection according to an embodiment of the disclosure. With reference to FIG. 1, a lidar device 200 has a light-emitting end EE and a light receiving end RE. The lidar device 200 includes a light source module 100, a light detector 210, and a light beam time difference timer 220. The light source module 100 is configured to provide a detection light beam DL, and is disposed at the light-emitting end EE. The light detector 210 is configured to receive the detection light beam DL reflected by an external object O, and is disposed at the light receiving end RE. The light beam time difference timer 220 is electrically connected to the light source module 100 and the light detector 210, and is configured to measure a time difference between emission and reception of the detection light beam DL and then calculate a distance difference between the external object O and the lidar device 200.

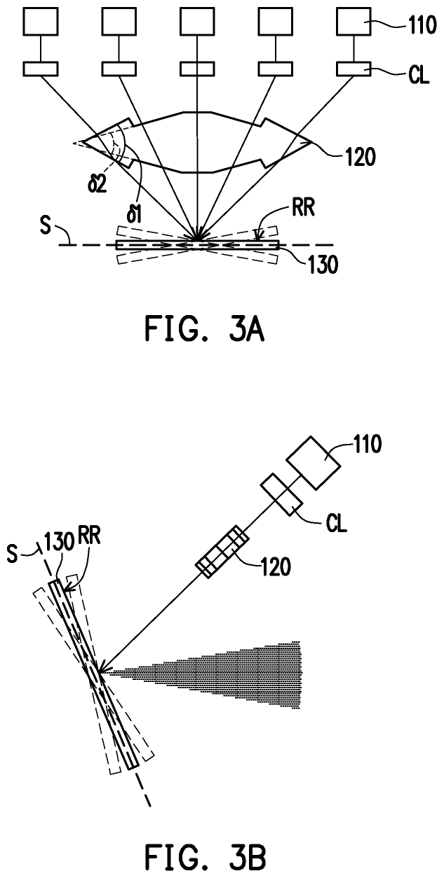

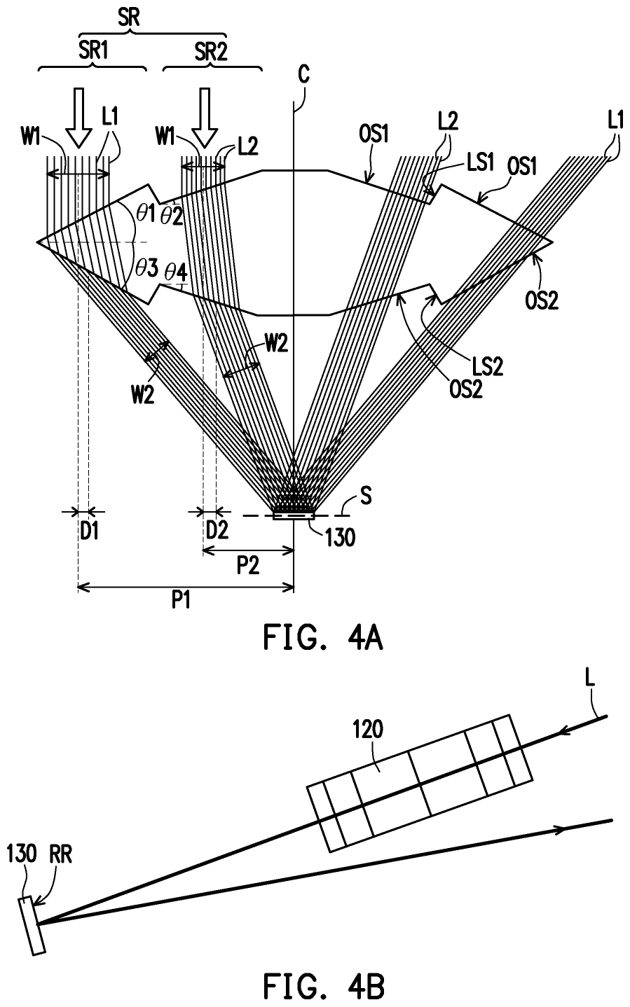

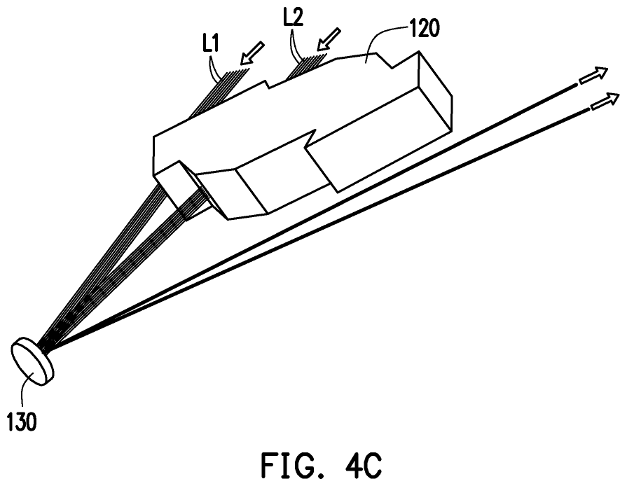

FIG. 2 is a schematic diagram of an internal architecture of the light source module of FIG. 1. FIG. 3A is a top view of the light source module of FIG. 2. FIG. 3B is a side view of the light source module of FIG. 2. FIG. 4A to FIG. 4C are schematic diagrams of light paths of the light source module of FIG. 2 in different view angles. Specifically, in this embodiment, as shown in FIG. 2 and FIG. 3A, the light source module 100 includes a plurality of light-emitting elements 110, a plurality of collimator lenses CL, a light spot shaping element 120, and a micro-mirror element 130. The light-emitting elements 110 are respectively configured to provide light beams L, and the light-emitting elements 110 are each arranged in parallel along a predetermined direction. The collimator lenses CL are located on a transmission path of each light beam L, such that each light beam L is formed into a parallel light beam. The light spot shaping element 120 has a plurality of light spot shaping regions SR. The light spot shaping regions SR are each located on the transmission path of each light beam L, and are respectively configured with different deflection angles and light beam convergence capabilities corresponding to the light beams L. The micro-mirror element 130 is located on a transmission path of the light beams L from the light spot shaping element 120. The micro-mirror element 130 has a central axis C (as shown in FIG. 4A). The central axis C passes through a center of the micro-mirror element 130, and is perpendicular to a reflecting surface RR of the micro-mirror element 130. When the micro-mirror element 130 stands still, the light-emitting elements 110 are each symmetrically disposed relative to the central axis C of the micro-mirror element 130. In addition, as shown in FIG. 3B, after being reflected by the micro-mirror element 130, the light beam L leaves the light source module 100 and forms the detection light beam DL.

In this embodiment, compared with a lidar device 200 in which light-emitting elements 110 of a light source module 100 are arranged in a fan shape, since the light-emitting elements 110 of the light source module 100 in the lidar device 200 are arranged in parallel along the predetermined direction, it facilitates control of angle tolerances of other components of the lidar device 200, thereby improving the accuracy of detection. In addition, in the lidar device 200, by increasing the light-emitting elements 110 in quantity, the light energy of the emitted detection light beam DL is also increased, thus increasing the measurement distance and improving the signal-to-noise (S/N) ratio, improving the resistance capability to stray light (e.g., sunlight/ambient light), and reducing the possibility of erroneous detection.

Besides, accompanied with FIG. 4A to FIG. 4C, further explanation will be provided hereinafter on the process of configuring the light spot shaping element 120 to increase light reception efficiency of the micro-mirror element 130. More specifically, as shown in FIG. 4A to FIG. 4C, the light spot shaping element 120 has a plurality of first optical surfaces OS1 and a plurality of second optical surfaces OS2, the first optical surfaces OS1 face the light-emitting elements 110, and the second optical surfaces OS2 face the micro-mirror element 130. The light spot shaping element 120 includes a plurality of first connecting surfaces LS1 and a plurality of second connecting surfaces LS2, the first connecting surfaces LS1 connect the plurality of first optical surfaces OS1 of adjacent ones of the light spot shaping regions SR, and the second connecting surfaces LS2 connect the plurality of second optical surfaces OS2 of adjacent ones of the light spot shaping regions SR. In addition, the light spot shaping element 120 is a single member.

Moreover, as shown in FIG. 4A, at least one of the first optical surfaces OS1 and at least one of the second optical surfaces OS2 are inclined relative to a swing axis S of the micro-mirror element 130, and an inclination direction of the at least one of the second optical surfaces OS2 relative to the swing axis S of the micro-mirror element 130 is opposite to an inclination direction of the at least one of the first optical surfaces OS1 relative to the swing axis S of the micro-mirror element 130. In this way, the at least one of the first optical surfaces OS1 has a formed deviation angle relative to the at least one of the second optical surfaces OS2, in another words, a deviation angle is formed between one of the first optical surfaces and one of the second optical surfaces correspondingly. As shown in FIG. 4A to FIG. 4C, by configuring the deviation angle, the lidar device 200 may be design by calculating a deflection angle of each light beam L passing through the light spot shaping element 120 based on control and design of multiple parameters such as material (refractive index), incidence angle, exiting angle, deviation angle, deviation displacement, among other parameters of the light spot shaping element 120, such that a position of an optical axis of each light beam L is closer toward the central axis C of the micro-mirror element 130.

For example, as shown in FIG. 4A to FIG. 4C, the light spot shaping regions SR include a first light spot shaping region SR1 and a second light spot shaping region SR2, and the second light spot shaping region SR2 is closer to the central axis C of the micro-mirror element 130 than the first light spot shaping region SR1. A deviation angle between the first optical surface OS1 and the second optical surface OS2 located in the first light spot shaping region SR1 is a first deviation angle δ1, and a deviation angle between the first optical surface OS1 and the second optical surface OS2 located in the second light spot shaping region SR2 is a second deviation angle δ2.

To be specific, in this embodiment, an inclination angle of the first optical surface OS1 located in the first light spot shaping region SR1 relative to the reflecting surface RR of the micro-mirror element 130 is a first inclination angle θ1, an inclination angle of the first optical surface OS1 located in the second light spot shaping region SR2 relative to the reflecting surface RR of the micro-mirror element 130 is a second inclination angle θ2, and as shown in FIG. 4A, the second inclination angle θ2 is smaller than the first inclination angle θ1. On the other hand, an inclination angle of the second optical surface OS2 located in the first light spot shaping region SR1 relative to the reflecting surface RR of the micro-mirror element 130 is a third inclination angle θ3, an inclination angle of the second optical surface OS2 located in the second light spot shaping region SR2 relative to the reflecting surface RR of the micro-mirror element 130 is a fourth inclination angle θ4, and as shown in FIG. 4A, the fourth inclination angle θ4 is smaller than the third inclination angle θ3. In addition, in this embodiment, since the inclination direction of the second optical surface OS2 relative to the swing axis S of the micro-mirror element 130 is opposite to the inclination direction of the first optical surface OS1 relative to the swing axis S of the micro-mirror element 130, thus the first deviation angle δ1 is the sum of the first inclination angle θ1 and the third inclination angle θ3, and the second deviation angle δ2 is the sum of the second inclination angle θ2 and the fourth inclination angle θ4. As a result, in this embodiment, as shown in FIG. 4A, the second deviation angle δ2 is smaller than the first deviation angle δ1. Furthermore, under this design, after passing through the light spot shaping element 120, the position of the optical axis of each light beam L is closer toward the central axis C of the micro-mirror element 130 based on refraction.

However, the light beams L require to first be collimated by the collimator lenses CL to satisfy the collimation requirements thereof, and depending on differences in the angle at which the light beams L are incident on the micro-mirror element 130, the micro-mirror element 130 also pose different range limitations on the light beams L incident at different incidence angles. Therefore, for light beams L incident on the micro-mirror element 130 at different incidence angles, light reception efficiency of the micro-mirror element 130 is also varied. For example, in this embodiment, assuming that a width of the reflecting surface RR of the micro-mirror element 130 is about 5 mm, then in the light beam L incident on the micro-mirror element 130 at an incidence angle of 40 degrees, only a light spot within a range of 5*cos(40°)=3.83 mm can be reflected by the micro-mirror element 130. In the light beam L incident on the micro-mirror element 130 at an incidence angle of 40 degrees, a light spot beyond the range of 3.83 mm cannot be reflected by the micro-mirror element 130 into effective light. Instead, stray light maybe formed, thus increasing noise. On the other hand, similarly, assuming that the light beam L of the second light spot shaping region SR2 is incident on the micro-mirror element 130 at an incidence angle of 20 degrees, then a light spot therein that can be reflected by the micro-mirror element 130 is within a width range of about 4.7 mm. Under the above conditions, assuming that a distance between the light-emitting elements 110 and the collimator lenses CL remains constant and other control factors remain the same, when the light beam L emitted by the light-emitting element 110 is directly incident on the micro-mirror element 130 at an incidence angle of 40 degrees after passing through the collimator lens CL, the light reception efficiency is about 63.4%, and when the light beam L emitted by the light-emitting element 110 is directly incident on the micro-mirror element 130 at an incidence angle of 20 degrees after passing through the collimator lens CL, the light reception efficiency is about 76.7%. That is to say, in the absence of the light spot shaping element 120, as the incidence angle of the light beam L incident on the micro-mirror element 130 increases, the light reception efficiency decreases, thus affecting the reliability of the lidar device 200.

In this regard, in this embodiment, by configuring the light spot shaping element 120, changes in the deflection angle of each light beam L passing through the light spot shaping element 120 can be controlled, and changes in a light beam width of each light beam L passing through the light spot shaping element 120 can also be controlled. Herein, a width dimension of each light beam L refers to the smallest dimension of a projection of each light beam L on a reference plane perpendicular to the direction in which the light beam L travels. For example, as shown in FIG. 4A, assuming that a width dimension of each light beam L entering each light spot shaping region SR of the light spot shaping element 120 is a first light beam width W1, a width dimension of each light beam L leaving each light spot shaping region SR of the light spot shaping element 120 is a second light beam width W2, then in the same light beam L, as shown in FIG. 4A to FIG. 4C, the second light beam width W2 is smaller than the first light beam width W1.

More specifically, as shown in FIG. 4A to FIG. 4C, in this embodiment, the first light beam widths W1 of the light beams L are different from each other, and the second light beam widths W2 of the light beams L are different from each other. The first light beam width W1 of a light beam L1 passing through the first light spot shaping region SR1 is larger than the first light beam width W1 of a light beam L2 passing through the second light spot shaping region SR2, and the second light beam width W2 of the light beam L1 passing through the first light spot shaping region SR1 is smaller than the second light beam width W2 of the light beam L2 passing through the second light spot shaping region SR2. In addition, as shown in FIG. 4A, the second light beam width W2 of each light beam L corresponds to the incidence angle of each light beam L incident on the reflecting surface RR of the micro-mirror element 130, such that a light spot dimension of each light beam L on the reflecting surface RR of the micro-mirror element 130 substantially coincides with a dimension of the reflecting surface RR of the micro-mirror element 130. That is to say, the light spot shaping regions SR of the light spot shaping element 120 have different light beam convergence capabilities, and based on the different incidence angles of the light beams L incident on the micro-mirror element 130, the light beam widths of the light beams L leaving the light spot shaping regions SR of the light spot shaping element 120 can be adjusted, thereby increasing the light reception efficiency of the micro-mirror element 130.

For example, as shown in FIG. 4A, it is assumed that the light beam L1 passing through the first light spot shaping region SR1 is incident on the reflecting surface RR of the micro-mirror element 130 at an incidence angle of 40 degrees, and the light beam L2 passing through the second light spot shaping region SR2 is incident on the reflecting surface RR of the micro-mirror element 130 at an incidence angle of 20 degrees. In this way, it may be so designed that a distance P1 between an optical axis of the light beam L1 passing through the first light spot shaping region SR1 and the central axis C of the micro-mirror element 130 is about 28.58 mm, a distance P2 between an optical axis of the light beam L2 passing through the second light spot shaping region SR2 and the central axis C of the micro-mirror element 130 is about 12.04 mm, the first deviation angle δ1 is about 56.08 degrees, the second deviation angle δ2 is about 35.74 degrees, a deviation displacement D1 of the light beam L1 passing through the first light spot shaping region SR1 is about 1.21 mm, and a deviation displacement D2 of the light beam L2 passing through the second light spot shaping region SR2 is about 1.61 mm. In addition, under the above parameter design, for the light beam L1 passing through the first light spot shaping region SR1, the width thereof can be reduced from the first light beam width W1 of 7.5 mm to the second light beam width W2 of 3.83 mm, and the light reception efficiency therefor can be increased to 95.6%, and for the light beam L2 passing through the second light spot shaping region SR2, the width thereof can be reduced from the first light beam width W1 of 5.2 mm to the second light beam width W2 of 4.7 mm, and the light reception efficiency therefor can be increased to 81.7%. As a result, by configuring the light spot shaping element 120, for the light beam L1 passing through the first light spot shaping region SR1, a gain in the light reception efficiency can reach 150.8%, and for the light beam L2 passing through the second light spot shaping region SR2, a gain in the light reception efficiency can also reach 106.5%. In this way, the lidar device 200 further increases the light energy of emitted the detection light beam DL, thereby increasing the measurement distance and improving the signal-to-noise ratio, thereby improving the accuracy of detection.

However, it is worth noting that, in the lidar device 200 of the disclosure, it is not required to limit the first light beam widths W1 of the light beams L passing through the different light spot shaping regions SR to being different with each other. In another embodiment, the first light beam widths W1 of the light beams L may also be the same as each other provided that, through adjusting other optical parameters (e.g., angle values of the first deviation angle δ1 and the second deviation angle δ2, the deviation displacement of each light beam L, and the like), the second light beam width W2 of each light beam L corresponds to the incidence angle of each light beam L incident on the reflecting surface RR of the micro-mirror element 130, and the light spot dimension of each light beam L on the reflecting surface RR of the micro-mirror element 130 substantially coincides with the dimension of the reflecting surface RR of the micro-mirror element 130.

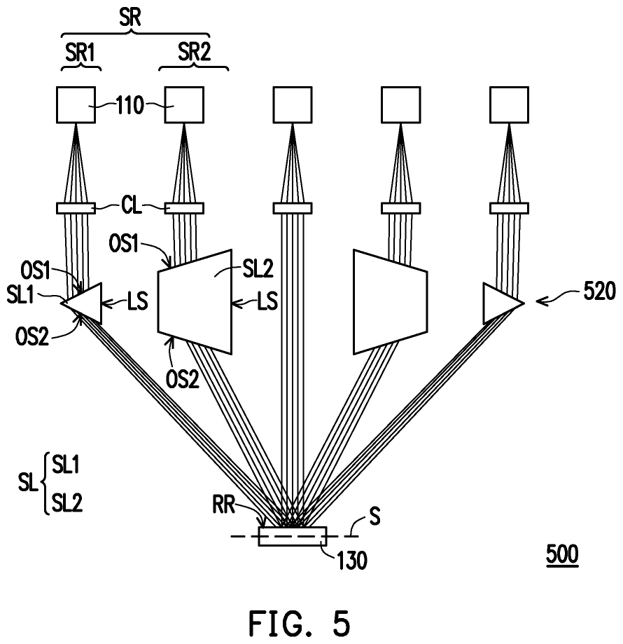

FIG. 5 is a schematic diagram of another architecture of the light source module of FIG. 1. With reference to FIG. 5, a light source module 500 of FIG. 5 is similar to the light source module 100 of FIG. 3A, and their differences are described below. In this embodiment, a light spot shaping element 520 of the light source module 500 includes a plurality of sub-light spot shaping elements SL. The sub-light spot shaping elements SL are separated from each other and are correspondingly located in the light spot shaping regions SR. In addition, the first optical surfaces OS1 are surfaces of the sub-light spot shaping elements SL facing the light-emitting elements 110, the second optical surfaces OS2 are surfaces of the sub-light spot shaping elements SL facing the micro-mirror element 130. Moreover, as shown in FIG. 5, each sub-light spot shaping element SL includes at least one connecting surface LS, and the at least one connecting surface LS connects the first optical surface OS1 and the second optical surface OS2. For example, when the number of the at least one connecting surface LS is one, the sub-light spot shaping element SL (e.g., a sub-light spot shaping element SL1 located in the first light spot shaping region SR1) is a prism, and when the number of the at least one connecting surface LS is two, the sub-light spot shaping element SL (e.g., a sub-light spot shaping element SL2 located in the second light spot shaping region SR2) is a wedge-shaped element.

In this way, by configuring the sub-light spot shaping elements SL located in the light spot shaping regions SR, the light spot shaping regions SR of the light spot shaping element 520 of the light source module 500 also deflect the light beams L to different degrees and have different light beam convergence capabilities corresponding to the light beams L, and based on the different incidence angles of the light beams L incident on the micro-mirror element 130, the light beam widths of the light beams L leaving the light spot shaping regions SR of the light spot shaping element 520 can be adjusted, thereby increasing the light reception efficiency of the micro-mirror element 130, such that the light source module 500 also achieves similar effects and advantages to those of the light source module 100, which will not be repeatedly described herein. Moreover, when the light source module 500 is applied to the lidar device 200 of FIG. 1, the lidar device 200 also achieves similar effects and advantages, which will not be repeatedly described herein.

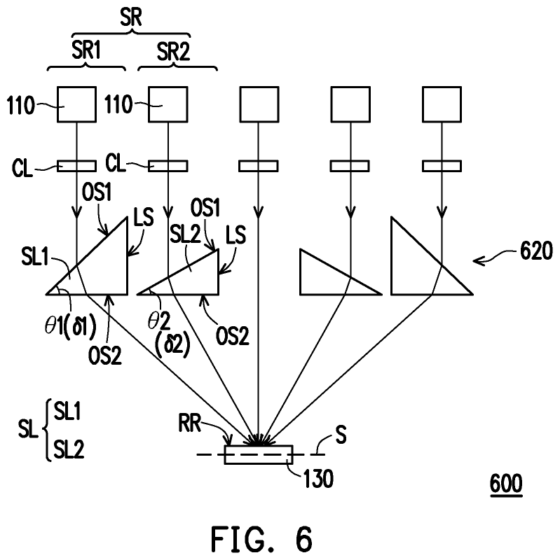

FIG. 6 is a schematic diagram of yet another architecture of the light source module of FIG. 1. With reference to FIG. 6, a light source module 600 of FIG. 6 is similar to the light source module 500 of FIG. 5, and their differences are described below. In this embodiment, the first optical surfaces OS1 of a light spot shaping element 620 are inclined relative to the swing axis S of the micro-mirror element 130, and the second optical surfaces OS2 are parallel to the swing axis S of the micro-mirror element 130. The inclination angle of the first optical surface OS1 located in the first light spot shaping region SR1 relative to the reflecting surface RR of the micro-mirror element 130 is the first inclination angle θ1, the inclination angle of the first optical surface OS1 located in the second light spot shaping region SR2 relative to the reflecting surface RR of the micro-mirror element 130 is the second inclination angle θ2, and the second inclination angle θ2 is smaller than the first inclination angle θ1. Moreover, in this embodiment, the first deviation angle δ1 is namely the first inclination angle θ1, and the second deviation angle δ2 is namely the second inclination angle θ2. As a result, in this embodiment, by designing the first deviation angle δ1 and the second deviation angle δ2, the deflection angle of each light beam L passing through the light spot shaping element 120 can be calculated, such that the position of the optical axis of each light beam L is closer toward the central axis C of the micro-mirror element 130.

In this way, by configuring the sub-light spot shaping elements SL located in the light spot shaping regions SR, the light spot shaping regions SR of the light spot shaping element 620 also deflect the light beams L to different degrees and have different light beam convergence capabilities corresponding to the light beams L, and based on the different incidence angles of the light beams L incident on the micro-mirror element 130, the light beam widths of the light beams L leaving the light spot shaping regions SR of the light spot shaping element 620 can be designed to adjust, thereby increasing the light reception efficiency of the micro-mirror element 130, such that the light source module 600 also achieves similar effects and advantages to those of the light source module 500, which will not be repeatedly described herein. Moreover, when the light source module 600 is applied to the lidar device 200 of FIG. 1, the lidar device 200 also achieves similar effects and advantages, which will not be repeatedly described herein.

In summary of the foregoing, the embodiment of the disclosure has at least one of the following advantages or effects. In the embodiment of the disclosure, in the light source module and the lidar device, since the light-emitting elements are arranged in parallel along the predetermined direction, it facilitates control of angle tolerances of other components of the lidar device, thereby improving the accuracy of detection. In addition, in the light source module and the lidar device, by increasing the light-emitting elements in quantity, the light energy of the emitted detection light beam is also increased. Besides, in the light source module and the lidar device, each of the light spot shaping regions of the light spot shaping element is configured to deflect the light beams to different degrees, and has different light beam convergence capabilities corresponding to the light beams, and based on the different incidence angles of the light beams incident on the micro-mirror element, the light beam widths of the light beams leaving the light spot shaping regions of the light spot shaping element can be adjusted, thereby increasing the light reception efficiency. In this way, in the lidar device, the light energy of the emitted detection light beam is further increased, thereby increasing the measurement distance and improving the signal-to-noise ratio, and improving the accuracy of detection.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light source module, the light source module comprising a plurality of light-emitting elements, a light spot shaping element, and a micro-mirror element, wherein
the light-emitting elements are respectively configured to provide light beams, wherein each of the light-emitting elements are arranged in parallel along a predetermined direction;
the light spot shaping element has a plurality of light spot shaping regions, the light spot shaping regions are configured with different deflection angles and light beam convergence capabilities respectively corresponding to the light beams, and each of the light spot shaping regions is located on a transmission path of each of the light beams, wherein a width dimension of each of the light beams entering each of the light spot shaping regions of the light spot shaping element is a first light beam width, a width dimension of each of the light beams leaving each of the light spot shaping regions of the light spot shaping element is a second light beam width, and in the same light beam, the second light beam width is smaller than the first light beam width; and
the micro-mirror element is located on a transmission path of the light beams from the light spot shaping element, wherein the second light beam width of each of the light beams corresponds to an incidence angle of each of the light beams incident on a reflecting surface of the micro-mirror element, such that a light spot dimension of each of the light beams on the reflecting surface of the micro-mirror element substantially coincides with a dimension of the reflecting surface of the micro-mirror element.

2. The light source module according to claim 1, wherein the micro-mirror element has a central axis, the central axis passes through a center of the micro-mirror element and is perpendicular to the reflecting surface of the micro-mirror element, and the light-emitting elements are each symmetrically disposed relative to the central axis of the micro-mirror element.

3. The light source module according to claim 2, wherein the light spot shaping element has a plurality of first optical surfaces and a plurality of second optical surfaces, the first optical surfaces face the light-emitting elements, the second optical surfaces face the micro-mirror element, a deviation angle is formed between one of the first optical surfaces and one of the second optical surfaces correspondingly, and after each of the light beams passes through the light spot shaping element, a position of an optical axis of each of the light beams is closer toward the central axis of the micro-mirror element.

4. The light source module according to claim 3, wherein the light spot shaping regions comprise a first light spot shaping region and a second light spot shaping region, the second light spot shaping region is closer to the central axis of the micro-mirror element than the first light spot shaping region, the deviation angle between the one of the first optical surfaces and the one of the second optical surfaces located in the first light spot shaping region is a first deviation angle, a deviation angle between another one of the first optical surfaces and another one of the second optical surfaces located in the second light spot shaping region is a second deviation angle, and the second deviation angle is smaller than the first deviation angle.

5. The light source module according to claim 4, wherein the second light beam width of the light beam passing through the first light spot shaping region is smaller than the second light beam width of the light beam passing through the second light spot shaping region.

6. The light source module according to claim 3, wherein the one of the first optical surfaces and the one of the second optical surfaces are inclined relative to a swing axis of the micro-mirror element, and an inclination direction of the one of the second optical surfaces relative to the swing axis of the micro-mirror element is opposite to an inclination direction of the one of the first optical surfaces relative to the swing axis of the micro-mirror element.

7. The light source module according to claim 3, wherein the one of the first optical surfaces is inclined relative to a swing axis of the micro-mirror element, and the one of the second optical surfaces is parallel to the swing axis of the micro-mirror element.

8. The light source module according to claim 3, wherein the light spot shaping element comprises a plurality of first connecting surfaces and a plurality of second connecting surfaces, the first connecting surfaces connect the first optical surfaces of adjacent ones of the light spot shaping regions, the second connecting surfaces connect the second optical surfaces of adjacent ones of the light spot shaping regions, and the light spot shaping element is a single member.

9. The light source module according to claim 3, wherein the light spot shaping element comprises a plurality of sub-light spot shaping elements, the sub-light spot shaping elements are separated from each other and are correspondingly located in the light spot shaping regions, the first optical surfaces are surfaces of the sub-light spot shaping elements facing the light-emitting elements, and the second optical surfaces are surfaces of the sub-light spot shaping elements facing the micro-mirror element.

10. The light source module according to claim 1, the light source module further comprising:
a plurality of collimator lenses located on the transmission path of each of the light beams, such that each of the light beams is formed into a parallel light beam.

11. A lidar device having a light-emitting end, the lidar device comprising a light source module, wherein
the light source module is configured to provide a detection light beam, and the light source module comprises a plurality of light-emitting elements, a light spot shaping element, and a micro-mirror element, wherein
the light-emitting elements are respectively configured to provide light beams, wherein each of the light-emitting elements are arranged in parallel along a predetermined direction;
the light spot shaping element has a plurality of light spot shaping regions, the light spot shaping regions are configured with different deflection angles and light beam convergence capabilities respectively corresponding to the light beams, and each of the light spot shaping regions is located on a transmission path of each of the light beams, wherein a width dimension of each of the light beams entering each of the light spot shaping regions of the light spot shaping element is a first light beam width, a width dimension of each of the light beams leaving each of the light spot shaping regions of the light spot shaping element is a second light beam width, and in the same light beam, the second light beam width is smaller than the first light beam width; and
the micro-mirror element is located on a transmission path of the light beams from the light spot shaping element, wherein the second light beam width of each of the light beams corresponds to an incidence angle of each of the light beams incident on a reflecting surface of the micro-mirror element, such that a light spot dimension of each of the light beams on the reflecting surface of the micro-mirror element substantially coincides with a dimension of the reflecting surface of the micro-mirror element, and each of the light beams is reflected by the micro-mirror element to form the detection light beam, the detection light beam leaving the lidar device through the light-emitting end.

12. The lidar device according to claim 11, wherein the micro-mirror element has a central axis, the central axis passes through a center of the micro-mirror element and is perpendicular to the reflecting surface of the micro-mirror element, and the light-emitting elements are each symmetrically disposed relative to the central axis of the micro-mirror element.

13. The lidar device according to claim 12, wherein the light spot shaping element has a plurality of first optical surfaces and a plurality of second optical surfaces, the first optical surfaces face the light-emitting elements, the second optical surfaces face the micro-mirror element, a deviation angle is formed between one of the first optical surfaces and one of the second optical surfaces correspondingly, and after each of the light beams passes through the light spot shaping element, a position of an optical axis of each of the light beams is closer toward the central axis of the micro-mirror element.

14. The lidar device according to claim 13, wherein the light spot shaping regions comprise a first light spot shaping region and a second light spot shaping region, the second light spot shaping region is closer to the central axis of the micro-mirror element than the first light spot shaping region, the deviation angle between the one of the first optical surfaces and the one of the second optical surfaces located in the first light spot shaping region is a first deviation angle, a deviation angle between another one of the first optical surfaces and another one of the second optical surfaces located in the second light spot shaping region is a second deviation angle, and the second deviation angle is smaller than the first deviation angle.

15. The lidar device according to claim 14, wherein the second light beam width of the light beam passing through the first light spot shaping region is smaller than the second light beam width of the light beam passing through the second light spot shaping region.

16. The lidar device according to claim 13, wherein the one of the first optical surfaces and the one of the second optical surfaces are inclined relative to a swing axis of the micro-mirror element, and an inclination direction of the one of the second optical surfaces relative to the swing axis of the micro-mirror element is opposite to an inclination direction of the one of the first optical surfaces relative to the swing axis of the micro-mirror element.

17. The lidar device according to claim 13, wherein the one of the first optical surfaces is inclined relative to a swing axis of the micro-mirror element, and the one of the second optical surfaces is parallel to the swing axis of the micro-mirror element.

18. The lidar device according to claim 13, wherein the light spot shaping element comprises a plurality of first connecting surfaces and a plurality of second connecting surfaces, the first connecting surfaces connect the first optical surfaces of adjacent ones of the light spot shaping regions, the second connecting surfaces connect the second optical surfaces of adjacent ones of the light spot shaping regions, and the light spot shaping element is a single member.

19. The lidar device according to claim 13, wherein the light spot shaping element comprises a plurality of sub-light spot shaping elements, the sub-light spot shaping elements are separated from each other and are correspondingly located in the light spot shaping regions, the first optical surfaces are surfaces of the sub-light spot shaping elements facing the light-emitting elements, and the second optical surfaces are surfaces of the sub-light spot shaping elements facing the micro-mirror element.

20. The lidar device according to claim 11, the light source module further comprising:
a plurality of collimator lenses located on the transmission path of each of the light beams, such that each of the light beams is formed into a parallel light beam.
